(19) United States
(12) Patent Application Publication
(10) Pub. No.: US 2011/0204591 A1
(43) Pub. Date: Aug. 25, 2011

(54) WHEELCHAIR, INVALID CHAIR OR THE LIKE

(75) Inventor: Stephan Gerster, Wachtberg-Pech (DE)

(73) Assignee: SOEHNLE PROFESSINAL GMBH & CO. KG, BACKNANG (DE)

(21) Appl. No.: 12/377,715

(22) PCT Filed: Aug. 7, 2007
(86) PCT No.: PCT/DE07/01396

§ 371 Date: Oct. 5, 2010

(30) Foreign Application Priority Data
Aug. 17, 2006 (DE) 10-2006-038-630.2

(51) Int. Cl. A61G 5/00

(52) U.S. Cl. 280/304.1

(57) ABSTRACT

A wheelchair includes a frame, a seat supported by the frame and a plurality of wheels. The wheelchair further includes at least one load cell disposed between at least one of the frame and the seat and at least one of the wheels and configured to provide at least one measured signal and a measuring device having at least one electrode disposed in at least one of the frame, a handle associated with the frame and an armrest associated with the frame, and configured to provide measured body-specific information. An evaluation unit is included in the wheelchair that has a power source, a processor, and a display, and configured to evaluate the at least one measured signal and the measured body-specific information and show processed data on the display.

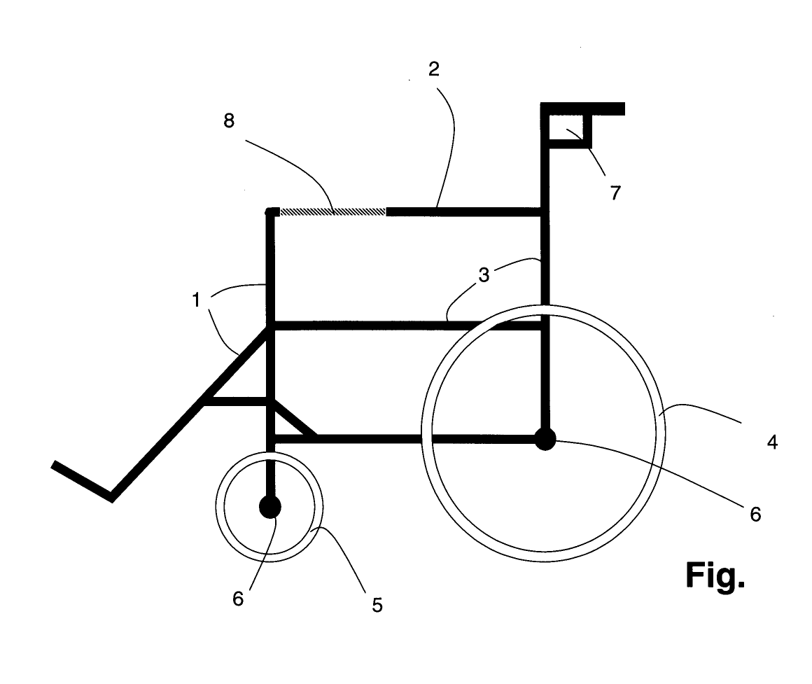

This is a U.S. National Phase Application under 35 U.S.C. §371 of International Application No. PCT/DE 2007/001396, filed on Aug. 7, 2007, which claims priority to DE 10 2006 038 630.2, filed on Aug. 17, 2006. The International Application was published in German on Feb. 21, 2008 as WO 2008/019655 A1 under PCT article 21 (2).

### FIELD

The present invention relates to a wheelchair, hospital chair or the like, comprising a frame, optionally with armrests that are joined to the frame, a seat supported by the frame, and wheels.

### BACKGROUND

Wheelchairs, hospital chairs, etc. with an integrated set of scales, in other words, with integrated weight measurement of the person sitting in them, have been known in actual practice for quite some time. In such cases, the load cells needed for the weighing procedure normally operate between the frame or the seat and the wheels. Hospital chairs thus equipped are usually employed to check the weight of persons who have difficulty standing or who are bedridden. These hospital chairs are easy to handle since the person simply has to sit in the chair. In a manner similar to modern scales, a processor and a memory are provided in a housing, whereby the selected and optionally processed data is shown on an LCD display. The operation is like that of a commercially available set of scales having such features.

Aside from the weight, there is also a need to acquire additional body-specific data, as is normally the case with scales having an integrated fat-measuring function. Such scales with an integrated fat-measuring function usually operate according to the so-called bioimpedance method. The weighing platform or base where the person stands to be weighed is equipped with electrically conductive electrodes which, in turn, are fed with a low current. This current is passed through the body of the user, as a result of which the body-specific electric resistance can be determined. This body resistance and the weight ascertained by means of the load cell as well as, optionally, other body-specific data—if applicable, gender, age, etc.—then make it possible to determine the fat content.

The scales with an integrated fat-measuring function known from the state of the art, however, are problematic for wheelchair users and bedridden persons since it is virtually impossible to place these persons onto such scales.

### SUMMARY

An aspect of the present invention is to provide a generic wheelchair, hospital chair or the like with which not only the weight but also additional body-specific information can be acquired.

In an embodiment, the present invention provides a wheelchair including a frame, a seat supported by the frame and a plurality of wheels. The wheelchair further includes at least one load cell disposed between at least one of the frame and the seat and at least one of the wheels and configured to provide at least one measured signal and a measuring device having at least one electrode disposed in at least one of the frame, a handle associated with the frame and an armrest associated with the frame, and configured to provide measured body-specific information. An evaluation unit is included in the wheelchair that has a power source, a processor, and a display, and configured to evaluate the at least one measured signal and the measured body-specific information and show processed data on the display.

### BRIEF DESCRIPTION OF THE DRAWINGS

Preferred versions and refinements of the teaching are also elaborated upon in general in conjunction with the explanation of an embodiment of the invention making reference to the drawing.

The only figure shows a schematic view of an embodiment of the wheelchair according to the invention with an integrated set of scales and with a body-fat measuring device.

### DETAILED DESCRIPTION

In an embodiment, the present invention provides a wheelchair, hospital chair or the like, comprising a frame, optionally with armrests that are joined to the frame, a seat supported by the frame, and wheels, whereby load cells are provided between the frame and/or the seat and the wheels, preferably in or on the wheel axles, for purposes of weight measurement, and whereby the measured signals are evaluated in an evaluation unit comprising a source of power, a processor and optionally a memory, and the processed data, particularly the weight of the person sitting in the wheelchair, is shown on a display.

In an embodiment, the present invention provides a wheelchair, hospital chair or the like in which, for purposes of determining other body-specific information, especially for ascertaining the body fat (the percentage of fat, water and muscle), an additional measuring device with electrodes is provided, whereby the electrodes are installed in the frame or in the armrest or in extra handles, and whereby the appertaining measured values are fed to the evaluation unit.

It has been recognized according to the invention that the means for determining body-specific information, in addition to the means for determining the body weight, can be integrated into the wheelchair. Thus, it is conceivable to calculate the body fat, that is to say, the percentage of fat, water and muscle in the body of the person sitting in the wheelchair or hospital chair. For this purpose, an additional measuring device with electrodes is provided, whereby the electrodes are installed in the frame or in the armrest or in extra handles, and whereby the appertaining measured values are fed to the evaluation unit, which also serves to determine the weight.

In the manner according to the invention, it has been recognized that the determination of other body-specific information is possible on or in the wheelchair, namely, when an additional measuring device with electrodes is provided which, for instance, is suitable for the use of the bioimpedance method. For this method, it is fundamentally possible to ascertain all of the factors that have a correlation with the ascertainable body resistance and the ascertained weight. Thus, on the basis of the measured values, it is fundamentally conceivable that information can be derived pertaining to the health condition of a given person.

The electrodes basically can be installed in the frame of the wheelchair, which is usually made of metal. In particular, the electrodes can be installed in the armrests so that, when the hand or arm makes contact with the armrests, a measurement employing the bioimpedance method can be carried out.

It is likewise conceivable for the electrodes to be installed in additional handles that can be mounted onto the frame of the wheelchair or that can be handled separately along the lines of lightweight dumbbells or the like.

The electrodes can also be installed in an additional plate—similar to a desk pad—whereby the plate is provided with the material of the electrodes in two zones that are separated from each other. The measurement can be made in that the person to be measured places his/her hands or arms onto the zones that are separated from each other, thus establishing electric contact with the body.

In an advantageous manner, the electrodes are produced by applying a surface coating onto the parts carrying the electrodes, especially by means of vapor deposition with metal or with another electrically conductive layer.

The electrodes or the parts carrying the electrodes can be connected to the evaluation unit with or without contact. In the case of the contactless embodiment, a transmitter-receiver system has to be provided.

Furthermore, it is advantageous if the evaluation unit and optionally the parts that carry the electrodes can be removed from the wheelchair. In this manner, the measuring device can be employed universally on different wheelchairs.

There are numerous possibilities to configure and refine the teaching according to the invention in an advantageous manner.

The single figure shows a schematic view of the wheelchair consisting essentially of a frame 1, armrests 2 joined to the frame 1, a seat 3 supported by the frame 1 and two large wheels 4 in the rear as well as two small wheels 5 in the front, whereby the small wheels 5 serve as steering wheels.

Load cells—not visible in the figure —serve to ascertain the weight and are installed in the wheel axles.

Furthermore, in the embodiment selected here, an evaluation unit 7 is installed in the back part of the seat 3 and it comprises a processor and a memory as well as a source of power, said evaluation unit serving to evaluate or process the measured signals. Moreover, the evaluation unit 7 comprises a display to show the measured results.

In the manner according to the invention, an additional measuring device is provided for purposes of ascertaining other body-specific information, especially for ascertaining the body fat, that is to say, the percentage of fat, water and muscle in the body. This measuring device comprises electrodes 8 which, in the embodiment selected here, are integrated into the armrests 2. By the same token, additional handles, a plate or other carriers can be provided for the electrodes, whereby two separate electrodes are required that serve to make contact with the hands or arms of the person in question. Likewise conceivable would be to provide electrodes in the form of cuffs that can be placed or fastened around the wrists or the ankles. They could conceivably also be secured with a rubber band or velcro.

In conclusion, it should be pointed out that the embodiment presented above serves merely as an example of the claimed teaching but that the latter is not restricted to this embodiment.

1-9. (canceled)

10. A wheelchair comprising:
a frame;
a seat supported by the frame;
a plurality of wheels;
at least one load cell disposed between at least one of the frame and the seat and at least one of the wheels and configured to provide at least one measured signal;
a measuring device having at least one electrode disposed in at least one of the frame, a handle associated with the frame and an armrest associated with the frame, and configured to provide measured body-specific information; and
an evaluation unit having a power source, a processor, and a display, and configured to evaluate the at least one measured signal and the measured body-specific information and show processed data on the display.

11. The wheelchair as recited in claim 10, wherein the wheelchair is a hospital chair.

12. The wheelchair as recited in claim 10, wherein the at least one load cell is disposed in or on an axle of the wheels.

13. The wheelchair as recited in claim 10, wherein the processed data includes a weight of a person sitting in the wheel chair.

14. The wheelchair as recited in claim 10, wherein the evaluation device includes a memory.

15. The wheelchair as recited in claim 10, wherein the measured body-specific information includes percentage of body fat, water, and muscle.

16. The wheelchair as recited in claim 10, wherein the at least one electrode is disposed in the frame.

17. The wheelchair as recited in claim 10, wherein the at least one electrode is disposed in the armrest.

18. The wheelchair as recited in claim 10, wherein the at least one electrode is disposed in the handle.

19. The wheelchair as recited in claim 10, wherein the at least one electrode is disposed in a plate associated with the frame.

20. The wheelchair as recited in claim 19, wherein the plate includes at least two zones separated from each other, the at least two zones including a material of the at least one electrode.

21. The wheelchair as recited in claim 10, wherein the at least one electrode includes a surface coating on a portion of the wheelchair.

22. The wheelchair as recited in claim 21, wherein the surface coating is a vapor deposition-deposited coaling.

23. The wheelchair as recited in claim 10, wherein the at least one electrode is connected to the evaluation unit with physical contact.

24. The wheelchair as recited in claim 10, wherein the at least one electrode is connected to the evaluation unit without physical contact.

25. The wheelchair as recited in claim 10, wherein the evaluation unit is removeable from the wheelchair.

26. The wheelchair as recited in claim 10, wherein at least one of the handle and the armrest is removeable from the wheelchair.
